(19) United States
(12) Patent Application Publication
(10) Pub. No.: US 2021/0019788 A1
(43) Pub. Date: Jan. 21, 2021

(54) LOCATION-BASED MOBILE PROMOTION CAMPAIGN

(71) Applicant: T-Mobile USA, Inc., Bellevue, WA (US)

(72) Inventors: Kanakrai Chauhan, Snoqualmie, WA (US); Cole Halverson, Seattle, WA (US)

(21) Appl. No.: 16/517,287

(22) Filed: Jul. 19, 2019

(51) Int. Cl. G06Q 30/02

(52) U.S. Cl. CPC G06Q 30/0266; G06Q 30/0271

(57) ABSTRACT

The use of location-based mobile promotion campaigns may enable a merchant to target the campaigns to customers who are located within specific geographical regions. A mobile campaign vehicle implementing a mobile promotion campaign may be determined to be at or within a predetermined distance of a campaign stop location for the mobile promotion campaign. The mobile promotion campaign for providing a promotional product or a promotional service. The location information reported by multiple user devices of subscribers may be analyzed to select a set of subscribers that are within a predetermined geofenced zone that encompasses the campaign stop location of the mobile campaign vehicle. Accordingly, information on the mobile promotion campaign may be sent along with the campaign stop location of the mobile campaign vehicle to at least one user device of one or more subscribers of the set of subscribers that are within the predetermined geofenced zone.

### BACKGROUND

A merchant may push promotion information to mobile applications that are installed user devices to notify customers of current promotion campaigns, e.g., offers, deals, discounts, gifts, and/or prizes. The mobile promotion campaigns may be sponsored by the merchant or sponsored by third-party business partners of the merchant. The promotion information for a promotion campaign may include a campaign start date, campaign end date, the promotional service or product being offered by the campaign, and promotion redemption parameters.

However, promotion information that is pushed to the mobile application of user devices regardless of the locations of the user devices may result in customers receiving promotion information for promotion campaigns that are unavailable in their area. For example, a customer may be presented with an offer to redeem a free product at a particular chain of retailers when the chain of retailers does not operate near the home area of the customer. Such misinformation may result in the merchant wasting advertising funds and resources, as well as potential customer dissatisfaction with the merchant.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture that enables a merchant to conduct mobile promotion campaigns to promote the promotional products or services provided by the merchant.

FIG. 2 is a block diagram showing various components of an illustrative mobile device that interacts with a campaign engine for conducting mobile promotion campaigns to promote products or service provided by the merchant.

FIG. 3 is a block diagram showing various components of one or more illustrative computing devices that support a campaign engine for conducting mobile promotion campaigns to promote products or service provided by the merchant.

FIG. 4 is a flow diagram of an example process for providing information on a promotion campaign that promotes a promotional product along with a campaign stop location of a mobile campaign vehicle to user devices of subscribers.

FIG. 5 is a flow diagram of an example process for providing information on a promotion campaign that promotes a promotional service along with a campaign stop location of a mobile campaign vehicle to user devices of subscribers.

FIG. 6 is a flow diagram of an example process for sending real-time updated inventory information of a promotional product to a campaign engine.

FIG. 7 is a flow diagram of an example process for conducting a flash promotion campaign using a mobile campaign vehicle based on a proximity of the vehicle to a short-range communication beacon.

FIG. 8 is a flow diagram of an example process for generating a route for a mobile campaign vehicle based on the customer information and the historical location information of a set of subscribers.

FIG. 9 is a flow diagram of an example process for scheduling a subscription to a third-party location-based service (LBS) map library based on the start and the end of a mobile promotion campaign.

### DETAILED DESCRIPTION

This disclosure is directed to techniques that enable a merchant to conduct a mobile promotion campaign to publicize the promotional products or services provided by the merchant, as well as to generate goodwill towards the merchant. The merchant may be a promotional product seller, a promotional service provider, and/or a combination of both. In some embodiments, the mobile promotion campaign may be conducted using a mobile campaign vehicle that travels along a campaign route, in which locations of the mobile campaign vehicle that travel along the route are reported by a mobile device onboard the mobile campaign vehicle to a campaign engine of a campaign provider. The campaign provider may be the merchant or a third-party service provider hired by the merchant. For example, the mobile device may be an Internet-of-Things (IoT) device, a smartphone, or some other device with communication capabilities. In turn, the campaign engine may analyze the location information reported by multiple user devices of subscribers. The subscribers may be customers that have agreed to receive promotion campaign information from the merchant, as well as share their location information with the merchant. Accordingly, the campaign engine may analyze the location information of the subscribers to select a specific set of subscribers that are within a predetermined geofenced zone around a campaign stop location of the mobile campaign vehicle as the vehicle is at or within a predetermined distance of the campaign stop location. Accordingly, the campaign engine may send information on the mobile promotion campaign to the user devices of the specific set of subscribers. For example, the information on the mobile promotion campaign may include details regarding a campaign stop location of the mobile campaign vehicle, the promotional product or service that is offered for the mobile promotion campaign, the start date and time of the mobile promotion campaign, a price of the promotional product or service, the end date and time of the mobile promotion campaign, the terms and conditions of the mobile promotion campaign, the amount of time that the mobile campaign vehicle will remain at the campaign stop location, and/or so forth. The campaign engine may send information on the mobile promotion campaign to a client application on each of the user devices. In various instances, the client application may be a utility application that is developed by the merchant or a third-party partner of the merchant and distributed to the user devices of the subscribers. In some instances, the campaign engine may further post the information on the mobile promotion campaign along with the campaign stop location of the mobile campaign vehicle on a social media site, such as a microblogging website, a social networking website, and/or so forth. In this way, the same promotion campaign may be conducted at various locations via the mobile campaign vehicle to attract subscribers who are proximate to the various locations.

In some instances, the mobile device onboard the mobile campaign vehicle may also track inventories of individual promotional products that are carried onboard the mobile campaign vehicle. Such inventory information may be sent by the mobile device to the campaign engine. In turn, the campaign engine may send the inventory information along with the information on the mobile promotion campaign to the user devices of the specific set of subscribers and/or post such inventory information on social media sites. Thus, as the inventory tracked by the mobile device is updated, the mobile device may send updated inventory information to the user devices or post the inventory information on a social media site.

In additional instances, the specific set of subscribers that are to receive the information on the mobile promotion campaign may be further refined by the campaign engine. In such instances, the information on the mobile promotion campaign may be analyzed against the customer information of the subscribers in the specific set of subscribers. In this way, the campaign engine may identify subscribers that are most likely to respond to the mobile promotion campaign and send promotion campaign related information exclusively to the client applications on the user devices of such subscribers.

In other embodiments, the mobile device onboard the mobile campaign vehicle may be used to conduct location-based flash promotion campaigns. A flash promotion campaign is a mobile promotion campaign intended to last for a limited time duration that is shorter than a time duration of a normal promotion campaign. In such embodiments, the mobile device may detect that the mobile campaign vehicle is proximate to a flash promotion beacon that is placed at a specific location. The detection of the flash promotion beacon may cause the mobile device to notify an operator of the mobile campaign vehicle to stop at a specific location to conduct a flash promotion campaign. The mobile device may also notify the campaign engine that the mobile campaign vehicle has arrived at the specific location so that the campaign engine may send out information about the flash promotion campaign.

The flash promotion campaign may involve the distribution of units of one or more promotional products or instances of one or more promotional services at the specific location from the mobile campaign vehicle for a particular period of time. Accordingly, the information regarding the flash promotion campaign as sent out by the campaign engine may include countdown timer information regarding the remaining time duration of the campaign. The flash campaign information may be distributed to client applications on user devices of subscribers who are within a geofenced geographical zone that encompasses the specific location of the mobile campaign vehicle. In some instances, the campaign engine may further refine the subscribers who are to receive the flash campaign information based on the customer information of the subscribers. At the termination of the flash campaign duration, the mobile device on the mobile campaign vehicle may notify the operator to move the mobile campaign vehicle to conduct the flash promotion campaign at a new location. In this way, the mobile campaign vehicle may repeat the flash promotion campaign at various locations in the same manner. However, in other embodiments, the flash promotion campaign may be conducted concurrently with a regular mobile promotion campaign.

In additional embodiments, the campaign engine of the campaign provider may start and stop a subscription to a third-party location-based service (LBS) map library based on whether there are one or more ongoing mobile promotion campaigns. The third-party LBS map library provides the campaign engine with the ability to identify subscribers that are located within particular geofenced zones, as well as broadcast the location of the mobile campaign promotions for visualization on maps presented by the client applications. Accordingly, by only subscribing to the third-party LBS map library when there is an active promotion campaign, the campaign provider may minimize license or usage fees paid to a third-party provider of the LBS map library. In some instances, the campaign provider may also reduce the license or usage fees paid to the third-party provider by deactivating LBS functionalities of client applications on the user devices of subscribers that the campaign provider has deemed ineligible to participate in mobile promotion campaigns. This has the effect of reducing the usage instances of the third-party LBS map library. Alternatively, or concurrently, the campaign provider may deactivate LB S functionalities of client applications on the user devices of subscribers located in geographical regions not targeted by any ongoing mobile promotion campaign.

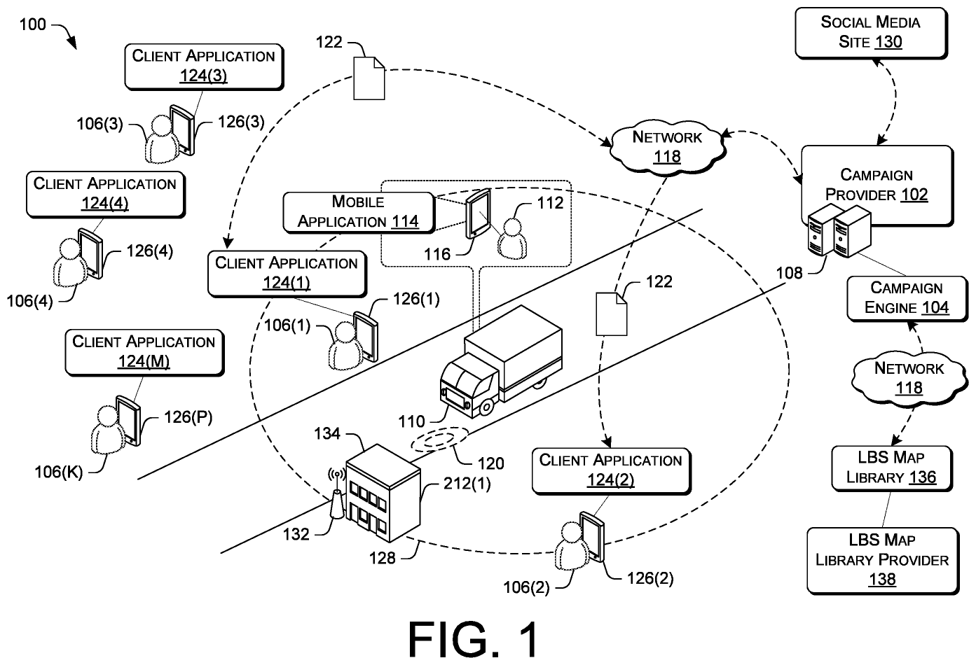

The use of location-based mobile promotion campaigns may enable a merchant to target the campaigns to customers who are located in specific geographical regions. Further, the use of location-based mobile promotion campaigns may make it more convenient for certain customers to take advantage of the campaigns due to the mobility and the proximity of the campaigns relative to the customers. The techniques described herein may be implemented in a number of ways. Example implementations are provided below with reference to the following FIGS. 1-9.

### Example Architecture

FIG. 1 illustrates an example architecture 100 that enables a merchant to conduct mobile promotion campaigns to promote the promotional products or services provided by the merchant. The campaign provider 102 may be a merchant who is a promotional product seller, a promotional service provider, and/or a combination of both. The campaign provider 102 may be a brick-and-mortar merchant or an online merchant that offers goods or services to consumers. Alternatively, the campaign provider 102 may be a third-party entity that is retained by the merchant to conduct the mobile promotion campaigns. The campaign provider 102 may operate a campaign engine 104 that distributes information on mobile promotion campaigns to subscribers, such as the subscribers 106(1)-106(K). The subscribers 106(1)-106(K) may be customers of the merchant that have agreed to receive promotion campaign information from the merchant, as well as share their location information with the merchant.

The campaign engine 104 may be implemented using software that is executed by one or more computing devices 108. A specific mobile promotion campaign that involves a promotional product may offer to provide the promotional product at no cost to subscribers, i.e., product giveaway, or provide the promotional product for purchase by subscribers at a discounted price. In some instances, the specific promotion campaign may be supplemented with an offer of an exclusive privilege or benefit along with a purchase of the promotional product, such as a complimentary gift, a free upgrade, etc. The promotional product that is the subject of the specific campaign may be a promotional product that is distributed by the merchant, or a promotional product that is distributed by a third-party affiliate of the merchant.

A particular mobile promotion campaign that involves a promotional service may offer the promotional service at no cost to subscribers or provide the promotional service for purchase or subscription by subscribers at a discount. In some instances, the particular promotion campaign may be supplemented with an offer of an exclusive privilege or benefit along with a purchase or subscription of the promotional service, such as a complimentary gift, a free service feature upgrade, free service for a predetermined duration, etc. The promotional service that is the subject of the particular promotion campaign may be a promotional service that is performed by the merchant, or a promotional service that is performed by a third-party affiliate of the merchant. The parameters of each mobile promotion campaign may be stored in a data store of the campaign engine 104. For example, the parameters for a mobile promotion campaign stored in the data store may include a description of the promotional product or service that is offered for the mobile promotion campaign, the start date and time of the mobile promotion campaign, the end date and time of the mobile promotion campaign, the details, terms, and conditions of the mobile promotion campaign, the geographical region targeted by the mobile promotion campaign, the quantity of products or services available for the mobile promotion campaign, the campaign route of a mobile campaign vehicle implementing the mobile promotion campaign, campaign stop criteria and campaign geographical area for the mobile promotion campaign, and/or so forth.

In some embodiments, the campaign provider 102 may conduct a mobile promotion campaign using a mobile campaign vehicle 110 that travels along a campaign route designated for the mobile promotion campaign. The route may contain predetermined locations where the mobile campaign vehicle 110 makes campaign stops. In some instances, the campaign stops and the time duration that the mobile campaign vehicle remains at each campaign stop may be preplanned as a part of the mobile promotion campaign. In such instances, the campaign stops are configured by the campaign provider 102 to provide subscribers with opportunities to receive the distribution of a promotional product or an opportunity to enroll in a promotional service via the mobile campaign vehicle. Accordingly, subscribers of the campaign provider 102 are able to obtain promotional products or services by interacting with a human operator 112 onboard the mobile campaign vehicle 110.

In such embodiments, a mobile application 114 on the mobile device 116 may receive the campaign parameters for a mobile campaign promotion from the campaign engine 104. The mobile device 116 may be an Internet-of-Things (IoT) device, a smartphone, or some other device with communication capabilities. The campaign engine 104 may communicate with the mobile device 116 via a network 118. The network 118 may include a wireless carrier network, a local area network (LAN), a wide area network (WAN), and/or so forth. Accordingly, the mobile application 114 may guides the human operator 112 of the mobile campaign vehicle 110 to drive the mobile campaign vehicle 110 along a campaign route and make campaign stops, such as the campaign stop 120. The locations of the mobile campaign vehicle 110 as the vehicle travel along the route are tracked by the mobile application 114. Once the mobile campaign vehicle 110 has reached a campaign stop that is predesignated or designated in real-time by an input from the human operator 112, the mobile application 114 may report to the campaign engine 104 that mobile campaign vehicle 110 has reached the campaign stop.

In turn, the campaign engine 104 may analyze the location information reported by client applications that reside on the multiple user devices of subscribers 106(1)-106(K), such as the client applications 124(1)-124(M) on the user devices 126(1)-126(P). In various instances, each of the user devices 126(1)-126(P) may be a smartphone, a tablet computer, a phablet, a personal digital assistant (PDA), or some other networked communication device. Further, each of the client applications 124(1)-124(M) may be a utility application that is developed by the campaign provider 102 or a third-party partner of the campaign provider 102 and distributed to the user devices of the subscribers. The client application on each user device may be stored in a memory of the user device and executed by a processor of the user device to communicate with the campaign engine 104 and to display information to a user. The campaign engine 104 may analyze the location information of the subscribers 106(1)-106(K) to select a specific set of subscribers that are within a predetermined geofenced zone 128 around a campaign stop location of the mobile campaign vehicle 110. For example, the campaign engine 104 may select the subscribers 106(1) and 106(2), but not subscribers 106(3)-106(K).

Subsequently, the campaign engine 104 may send information on the mobile promotion campaign to the client applications on the user devices of the specific set of subscribers. For example, the campaign engine 104 may send the campaign information 122 to the client applications 124(1) and 124(2) on the user devices 126(1) and 126(2), respectively. The information may be sent to the client applications via the network 118. For example, the information on the mobile promotion campaign may include information regarding a campaign stop location of the mobile campaign vehicle, the promotional product or service that is offered for the mobile promotion campaign, a description of the promotional product or service that is offered, the start date and time of the mobile promotion campaign at the location, the end date and time of the mobile promotion campaign at the location, the details, terms, and conditions of the mobile promotion campaign, the quantity of products or services available for the mobile promotion campaign, and/or so forth. In some embodiments, the information that is sent to a subscriber may include an electronic coupon or voucher that entitles the subscriber to take advantage of the promotional product or service offered by the mobile promotion campaign.

In some instances, the campaign engine 104 may further post the information on the mobile promotion campaign along with the campaign stop location of the mobile campaign vehicle on one or more social media sites, such as the social media site 130. Each of the social media sites may be a microblogging website, a social networking website, a bulletin board website, and/or so forth.

After stopping at the campaign stop for a period of time, the mobile application 114 may direct the human operator 112 to move the mobile campaign vehicle 110 to a next campaign stop on the campaign route, so that the mobile campaign promotion can be repeated at the next campaign stop, and so on, for the entire campaign route. Likewise, the campaign engine 104 may update the social media postings for each campaign stop.

In some instances, the mobile application 114 onboard the mobile campaign vehicle 110 may track an inventory of a promotional product that is carried onboard the mobile campaign vehicle for a promotion campaign. For example, the parameters for the mobile promotion campaign may stipulate a quantity of the promotional product that is to be distributed at each campaign stop and/or for the duration of the entire mobile promotion campaign. Thus, as subscribers obtain units of the promotional products, the mobile application 114 may track the number of units that have been distributed. Such tracking may be performed by using a scanner function of the mobile device 116 to scan a barcode, serial number, or another unit identifier that is present on the units of the promotional product for input into the mobile application 114. Alternatively, the human operator 112 may manually input such unit identifiers into the mobile application 114. In some instances, the scanner function may also be used to scan an electronic coupon or voucher that is presented by a subscriber via a client application of a user device to ensure that the subscriber is eligible to take advantage of the promotional product.

In other instances, the mobile application 114 onboard the mobile campaign vehicle 110 may track a number of times that the subscribers have redeemed a promotional service that is offered via a mobile promotion campaign. For example, the parameters for the mobile promotion campaign may stipulate instances of the promotional service being offered. Thus, as subscribers obtain instances of the promotional service, the mobile application 114 may track the number of instances that have been obtained. Such tracking may be performed by using a scanner function of the mobile device 116 to scan a barcode, serial number, or another instance identifier that is associated with each instance of the promotional service for input into the mobile application 114. Alternatively, the human operator 112 may manually input such instance identifiers into the mobile application 114. In some instances, the scanner function may also be used to scan an electronic coupon or voucher that is presented by a subscriber via a client application of a user device to ensure that the subscriber is eligible to take advantage of the promotional service.

The resulting product inventory or service instance information, e.g., redeemed and/or available units of a product or a service, may be sent by the mobile application 114 to the campaign engine 104. In turn, the campaign engine 104 may send the inventory or instance information along with the information on the mobile promotion campaign to the user devices of the specific set of subscribers. Alternatively, or concurrently, the campaign engine 104 may post such inventory information on social media sites. The inventory or instance information may be sent or posted in real-time or on a periodic basis. Thus, as the inventory or instance tracked by the mobile device is updated, the mobile device may send updated inventory or instance information to the user devices or post the updated inventory or instance information to one or more social media sites.

In additional embodiments, the specific set of subscribers that are to receive the information on the mobile promotion campaign may be further refined by the campaign engine 104. In such instances, the information on the mobile promotion campaign may be analyzed against the customer information of the subscribers in the specific set of subscribers that are with a geofenced zone. For example, the customer information of a subscriber, such as the subscriber 106(1), may include a promotional product purchase history, a promotional service purchase history, a payment history, a credit history, subscriber demographic information, social media activity data, and/or so forth. In this way, the campaign engine 104 may identify subscribers that are most likely to respond to the mobile promotion campaign and send the mobile promotion campaign related information exclusively to the client applications on the user devices of such subscribers.

In alternative embodiments, the human operator 112 onboard the mobile campaign vehicle may use the mobile application 114 on the mobile device 116 to designate campaign stops in a predetermined geographical area for a mobile promotion campaign. The human operator 112 may be permitted by the parameters of the mobile promotion campaign to designate campaign stops in real-time provided that certain campaign stop criteria of the mobile promotion campaign are met. The campaign stop criteria may dictate a minimal and/or maximum distance between each campaign stop, a minimum and/or maximum time duration to remain at each campaign stop, a minimal and/or a maximum number of campaign stops in the predetermined geographical area, and/or so forth.

In other embodiments, the mobile device 116 onboard the mobile campaign vehicle 110 may be used to conduct location-based flash promotion campaigns. A flash promotion campaign is a mobile promotion campaign that is intended to last for a limited time duration that is shorter than a time duration of a normal promotion campaign. In such embodiments, the mobile application 114 on the mobile device 116 may direct the human operator 112 to move the mobile campaign vehicle 110 along a preplanned campaign route based on one or more campaign parameters received from the campaign engine 104. Alternatively, the parameters for the flash promotion campaign may permit the human operator 112 to freely move the mobile campaign vehicle in a predetermined geographical area. Subsequently, the mobile application 114 may detect that the mobile campaign vehicle 110 is proximate to a flash promotion beacon 132 that is placed at a specific location. For example, the flash promotion beacon may be a short-range communication device, such as a Bluetooth IoT transceiver. The detection of the flash promotion beacon 132 may cause the mobile application 114 on mobile device 116 to notify the human operator 112 of the mobile campaign vehicle 110 to stop at the specific location to conduct a flash promotion campaign. The mobile application 114 may also notify the campaign engine 104 that the mobile campaign vehicle 110 has arrived at the specific location so that the campaign engine 104 may send out information about the flash promotion campaign.

The flash promotion campaign may involve the distribution of units of one or more promotional products or instances of one or more promotional services at the specific location from the mobile campaign vehicle 110 for a particular period of time. Accordingly, the information regarding the flash promotion campaign as sent out by the campaign engine 104 to the client applications of subscribers may include countdown timer information regarding the remaining time duration of the campaign. The flash campaign information may be distributed to client applications on user devices of subscribers who are within a geofenced geographical zone that encompasses the specific location of the mobile campaign vehicle. In some instances, the campaign engine may further refine the subscribers who are to receive the flash campaign information based on the customer information of the subscribers. In such instances, the information on the flash promotion campaign may be analyzed against the customer information of the subscribers in the specific set of subscribers that are within a geofenced zone. For example, the customer information of a subscriber may include a promotional product purchase history, a promotional service purchase history, a payment history, a credit history, subscriber demographic information, social media activity data, and/or so forth. In this way, the campaign engine 104 may identify subscribers that are most likely to respond to the flash promotion campaign and send the flash promotion campaign related information exclusively to the client applications on the user devices of such subscribers. The campaign engine 104 may further post the information on a flash promotion campaign, the campaign stop location of the mobile campaign vehicle, the total time duration and/or remaining time duration of the campaign at the campaign stop location on one or more social media sites, such as the social media site 130. Each of the social media sites may be a microblogging website, a social networking website, a bulletin board website, and/or so forth.

At the termination of the flash promotion campaign time duration, the mobile application 114 of the mobile device 116 on the mobile campaign vehicle 110 may notify the human operator 112 to move the mobile campaign vehicle 110 so that the flash promotion campaign may be conducted at a new location. In this way, the mobile campaign vehicle may repeat the flash promotion campaign at various locations in the same manner.

In alternative embodiments, the flash promotion campaign may involve the mobile campaign vehicle 110 dropping off a predetermined quantity of a promotional product at a brick-and-mortar storefront 134 that is proximate to the flash promotion beacon 132. The brick-and-mortar storefront 134 may be a store that is operated by the merchant or by a third-party merchant that is affiliated with the merchant. In such embodiments, the mobile application 114 may direct the human operator 112 to drop off the units of the promotional product according to one or more campaign parameters provided by the campaign engine 104. Following the drop off, the human operator may use the mobile application 114 to notify the campaign engine 104 that the drop off is complete. In turn, the flash campaign information that includes the name and location of the brick-and-mortar storefront 134 may be distributed by the campaign engine 104 to client applications on user devices of specific subscribers. The specific subscribers may be within a geofenced geographical zone that encompasses the specific location of the flash promotion beacon 132. In some instances, the campaign engine may further refine the subscribers who are to receive the flash campaign information based on the customer information of the subscribers. The campaign engine 104 may further post the flash campaign information to one or more social media sites. Further, the mobile application 114 on the mobile device 116 may notify the human operator 112 to resume traveling along the campaign route after the drop off.

Subsequently, the employees of the brick-and-mortar storefront 134 may handle the distribution of the promotional product (e.g., giveaways, sales, and/or so forth). In some instances, the flash promotion campaign may involve the mobile campaign vehicle 110 exclusively performing a series of such drop offs along a campaign route. In other instances, the flash promotion campaign may involve the mobile campaign vehicle 110 performing one or more drop offs in conjunction with one or more vehicle-based distribution of units of a promotional product or a promotional service. In some instances, the flash promotion campaign may be conducted concurrently with a regular mobile promotion campaign via the mobile campaign vehicle 110. For example, the mobile campaign vehicle 110 may encounter the flash promotion beacon 132 as the vehicle travels along a campaign route for the regular mobile promotion campaign. In other instances, multiple mobile promotion campaigns of any type may be concurrently conducted using the mobile campaign vehicle 110.

In additional embodiments, the campaign engine 104 of the campaign provider 102 may start and stop a subscription to a location-based service (LBS) map library 136 provided by a third-party LBS map library provider 138 based on whether there are one or more ongoing mobile promotion campaigns. The third-party LBS map library 136 provides the campaign engine 104 with the ability to identify subscribers that are located within particular geofenced zones, as well as broadcast the location of the mobile campaign promotions for visualization on maps presented by the client applications. The LBS map library 136 may be accessible to the campaign engine 104 via an application program interface (API) that is provided by the third-party service provider. For example, the API may be the Google Maps API provided by Google LLC or another API provided by another LBS map library service provider.

Accordingly, by only subscribing to the third-party LBS map library 136 when there is an active promotion campaign, the campaign provider 102 may minimize license or usage fees paid to a third-party provider of the LBS map library 136. For example, the campaign engine 104 may query the parameters of the mobile promotion campaigns to determine the start and end date and times of the campaigns. Based on this information, the campaign engine 104 may generate a schedule for activating a subscription to the LBS map library 136 for those times when an active mobile promotion campaign is ongoing, as well as deactivate the subscription to the LBS map library 136 when no active mobile promotion campaign is occurring.

In some instances, the campaign engine 104 may also reduce the license or usage fees paid to the third-party provider by deactivating LBS functionalities of client applications on the user devices of subscribers that the merchant has deemed ineligible to participate in mobile promotion campaigns. For example, the campaign engine 104 may deactivate the LBS functionalities of a client application belonging to a subscriber who carries an outstanding balance with the merchant, who is behind on payments to the merchant, who has a credit rating that is below a numerical threshold, and/or so forth. In instances in which the merchant is a wireless communication carrier, eligibility to participate in a mobile promotion campaign may be determined based on service plan level or type (e.g., prepaid, post-paid, rate plan, service tier, type or model of user device used to obtain service from the wireless communication carrier, etc.). This has the effect of reducing the usage instances of the third-party LBS map library 136. Alternatively, or concurrently, the campaign engine 104 may deactivate the LBS functionalities of client applications on the user devices of subscribers located in geographical regions not targeted by any ongoing mobile promotion campaign. For example, the campaign engine 104 may query the parameters of the mobile promotion campaigns to determine geographical regions with ongoing campaigns and the geographical locations of user devices with the client applications installed. By comparing such location information, the campaign engine 104 may deactivate the LBS functionalities of client applications that are currently not located in the geographical regions with ongoing campaigns.

### Example Mobile Application

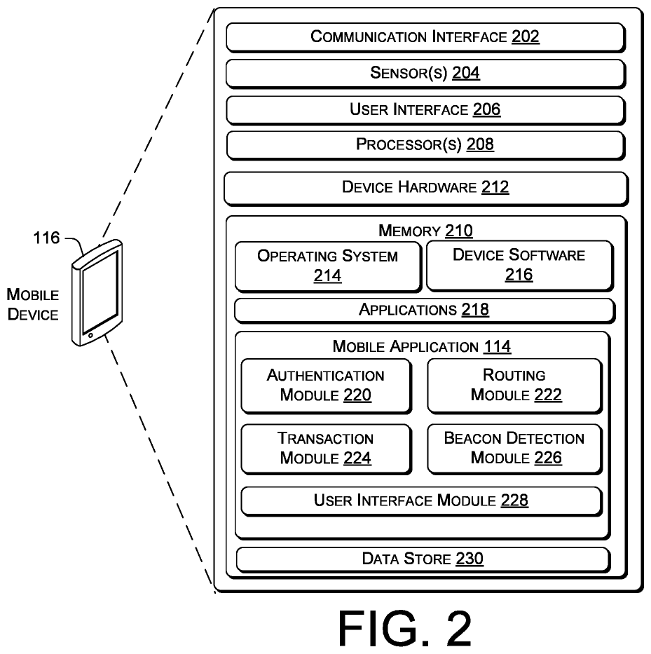

FIG. 2 is a block diagram showing various components of an illustrative mobile device that interacts with a campaign engine for conducting mobile promotion campaigns to promote products or service provided by the merchant. The mobile device 116 may include a communication interface 202, one or more sensors 204, a user interface 206, one or more processors 208, memory 210, and device hardware 212. The communication interface 202 may include wireless and/or wired communication transceiver components that enable the mobile device 116 to conduct long-range and short-range communication. Accordingly, the communication interface 202 may be used to transmit or receive data via a wireless carrier network, a local area network, a peer-to-peer network, etc. The sensors 204 may include a proximity sensor, a compass, an accelerometer, biometric sensors, cameras, and/or a global positioning system (GPS) sensor, a code scanner, among other appropriate sensors. The proximity sensor may detect the movement of objects that are proximate to the mobile device 116. The compass, the accelerometer, and the GPS sensor may detect orientation, movement, and geolocation of the mobile device 116. The cameras may capture images of the environment around the mobile device 116.

The user interface 206 may enable a user to provide inputs and receive outputs from the mobile device 116. The user interface 206 may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

The memory 210 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The device hardware 212 may include a cellular modem that enables the mobile device 116 to perform telecommunication and data communication with a network, as well as a short-range transceiver that enables the device to connect to other devices via short-range wireless communication links. The device hardware 212 may further include signal converters, antennas, hardware decoders and encoders, graphics processors, a universal integrated circuit card (UICC), an eUICC, and/or the like that enable the mobile device 116 to execute applications and provide telecommunication and data communication functions.

The one or more processors 208 and the memory 210 of the mobile device 116 may implement an operating system 214, device software 216, one or more applications 218, and a mobile application 114. Such software may include routines, program instructions, objects, and/or data structures that are executed by the processors 208 to perform particular tasks or implement particular abstract data types.

The operating system 214 may include components that enable the mobile device 116 to receive and transmit data via various interfaces (e.g., user controls, communication interface 202, and/or memory input/output devices). The operating system 214 may also process data using the one or more processors 208 to generate outputs based on inputs that are received via the user interface 206. For example, the operating system 214 may provide an execution environment for the execution of the applications 218. The operating system 214 may include a presentation component that presents the output (e.g., display the data on an electronic display, store the data in memory, transmit the data to another electronic device, etc.).

The operating system 214 may include an interface layer that enables applications to interface with the modem and/or the communication interface 202. The interface layer may comprise public APIs, private APIs, or a combination of both public APIs and private APIs. Additionally, the operating system 214 may include other components that perform various other functions generally associated with an operating system. The device software 216 may include software components that enable the user device to perform functions. For example, the device software 216 may include basic input/output system (BIOS), bootrom, or a bootloader that boots up the mobile device 116 and executes the operating system 214 following power-up of the device.

The applications 218 may include applications that provide utility, entertainment, and/or productivity functionalities to a user of the mobile device 116. For example, the applications 218 may include telephony applications, electronic mail applications, navigation applications, web browsing applications, and/or so forth. The mobile application 114 may include an authentication module 220, a routing module 222, a transaction module 224, a beacon detection module 226, and a user interface module 228.

The authentication module 220 may enable a human operator to submit login credentials to the mobile application 114. The login credentials may include a user identifier, a user password, user biometric data, and/or so forth. In turn, the authentication module 220 may use internally stored authentication data to verify the login credentials. Alternatively, the authentication module 220 may send the login credentials to the campaign engine 104 for authentication. Accordingly, if the login credentials submitted by the human operator are verified, the human operator may be granted access to use the mobile application 114. Otherwise, the human operator is denied access to the mobile application 114.

The routing module 222 may receive the parameters of a mobile promotion campaign from the campaign engine 104. The parameters may include a campaign route of the mobile promotion campaign, locations of the campaign stops along the campaign route, requirements for campaign stop locations, and/or so forth. Accordingly, the routing module 222 may use the LBS map library 136 to generate route guidance and stop guidance that is displayed by the mobile device 116 to a human operator, such as the human operator 112. Further, the routing module 222 may report information such as the geolocations of the mobile device 116, the duration of time the mobile device 116 is present at each campaign stop location, route-related information inputted by a human operator, distance to each subsequent campaign stop location, arrival at or departure from each campaign stop location, and/or other information to the campaign engine 104. The routing module 222 may present prompts that guide a human operator to follow the campaign route, depart a campaign stop location, travel to a subsequent campaign stop location, and/or adhere to a time schedule of a mobile promotion campaign based on the parameters of the mobile promotion campaign. In some instances, the routing module 222 may generate a detour path or way back path if the routing module 222 detects that the mobile device 116 has deviated from a designated campaign route.

The transaction module 224 may track the distribution of units of a promotional product or instances of a promotional service for a mobile promotion campaign. In some instances, the transaction module 224 may include a point-of-sale function that enables the human operator to sell units of a promotional product or a promotional service in exchange for monetary payment, such as cash or card payment. In other instances, the transaction module 224 may include a redemption function that enables the human operator to distribute units of a promotional product or a promotional service to subscribers in exchange for electronic coupons or vouchers that are presented by the subscribers. Additionally, the transaction module 224 may include a data intake function that enables the input of customer information, such as customer identification information, demographic information, etc. The customer information may be stored by the transaction module 224 in the data store 230 of the mobile device 116. Alternatively, the transaction module 224 may transmit the customer information to the campaign engine 104 for storage in a data store of the campaign engine 104. The transaction module 224 may further send inventory information regarding available units of a promotional product or available instances of a promotional service to the campaign engine 104. In turn, the campaign engine 104 may send the inventory information to the client applications on the user devices or post the inventory information to a social media site. In some embodiments, the transaction module 224 may also forward the inventory information to the routing module 222, so that the routing module 222 may direct a human operator to move the mobile campaign vehicle 110 to a subsequent campaign stop once a quantity of the promotional product or the promotional service designated for distribution at a particular campaign stop is exhausted.

The beacon detection module 226 may detect a flash promotion beacon, such as a flash promotion beacon 132, via a short-range transceiver of the communication interface 202. Following the detection of a flash promotion beacon, the beacon detection module 226 may alert the routing module 222 that the mobile device 116 is proximate to the location of a flash campaign stop. In turn, the routing module 222 may prompt the human operator to initiate a stop of the mobile campaign vehicle 110. In some instances, the beacon detection module 226 may send a notification to the campaign engine 104 indicating that a flash promotion beacon has been detected.

The user interface module 228 may enable a human operator to interact with the mobile application 114 via the user interface 206. For example, the human operator may input login credentials, customer information, inventory data, campaign stop locations, etc. using the user interface module 228. The data may store data that are processed or generated by the mobile application 114. The data store 230 may include one or more databases, such as relational databases, object databases, object-relational databases, and/or key-value databases that store data. For example, data stored in the data store 230 may include login credential authentication information, customer information, and/or other data.

### Example Campaign Engine Components

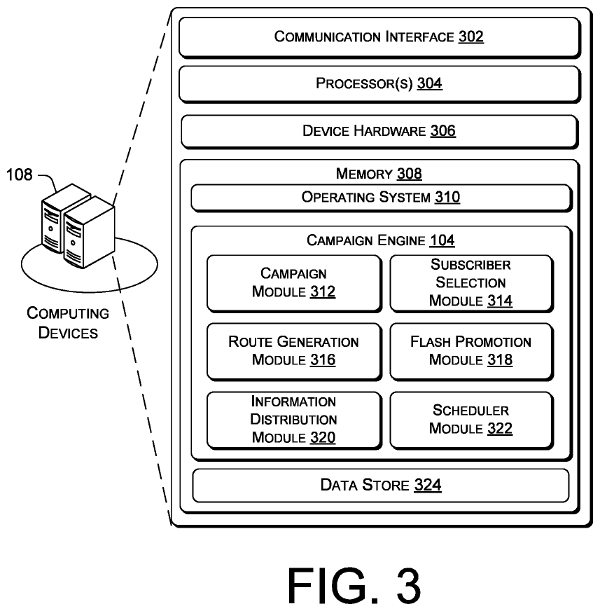

FIG. 3 is a block diagram showing various components of one or more illustrative computing devices that support a campaign engine for conducting mobile promotion campaigns to promote products or service provided by the merchant. The computing devices 108 may include a communication interface 302, one or more processors 304, memory 306, and device hardware 308. The communication interface 302 may include wireless and/or wired communication components that enable the computing devices 108 to transmit data to and receive data from other networked devices. The device hardware 308 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 306 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. In other embodiments, the computing devices 108 or components thereof may be virtual computing devices in the form of virtual machines or software containers that are hosted in a computing cloud.

The computing devices 108 may implement an operating system 310 and a campaign engine 104. The operating system 310 may include components that enable the computing devices 108 to receive and transmit data via various interfaces (e.g., user controls, communication interface, and/or memory input/output devices), as well as process data using the processors 304 to generate output. The operating system 310 may include a presentation component that presents the output (e.g., display the data on an electronic display, store the data in memory, transmit the data to another electronic device, etc.). Additionally, the operating system 310 may include other components that perform various additional functions generally associated with an operating system. The operating system 310 may support the operations of the campaign engine 104.

The campaign engine 104 may include a campaign module 312, a subscriber selection module 314, a route generation module 316, a flash promotion module 318, an information distribution module 320, and a scheduler module 322. Such modules may include routines, program instructions, objects, and/or data structures that are executed by the processors 208 to perform particular tasks or implement particular abstract data types.

The campaign module 312 may store the parameters of mobile promotion campaigns in a data store 324. In some instances, the parameters may be inputted by a user at a user device that communicates with the computing devices 108 via the network 118. In turn, the campaign module 312 may designate a particular mobile campaign vehicle, such as the mobile campaign vehicle 110, to carry out a mobile promotion campaign. Accordingly, the campaign module 312 may send the parameters of the mobile promotion campaign to the mobile device of a human operator that is assigned to the mobile promotion vehicle. In turn, the campaign module 312 may receive data related to the implementation of a mobile promotion campaign from a mobile application on the mobile device. For example, the data may include an overall quantity of products or services distributed for a mobile promotion campaign, a quantity of products or services distributed at each campaign stop, a quantity of available products or services remaining, dynamically generated content regarding a mobile promotion campaign, and/or so forth. In some instances, a promotional service that is distributed may be a special service that is related to the operations of the merchant. For example, the promotional service may be an employee recruitment initiative of the merchant to provide employment opportunity information and collect job application material from potential job applicants. The campaign module 312 may designate a mobile campaign vehicle to concurrently carry out multiple mobile promotion campaigns of any type as long as the parameters of the multiple mobile promotion campaigns do not conflict. Alternatively, or concurrently, the campaign module 312 may designate multiple mobile campaign vehicles to concurrently carry out different mobile promotion campaigns.

The subscriber selection module 314 may select subscribers to receive notifications regarding a mobile promotion campaign, which may be a regular mobile promotion campaign or a flash promotion campaign. The selection may be performed by the subscriber selection module 314 for the particular mobile promotion campaign when a corresponding mobile application indicates that an associated mobile campaign vehicle is at a campaign stop location designated for the mobile promotion campaign. Alternatively, the selection may be performed by the subscriber selection module 314 when the corresponding mobile application indicates that the associated campaign vehicle is within a predetermined distance of a campaign stop location while en route to the campaign stop location. In some embodiments, the subscriber selection module 314 may compare the location of a campaign stop to geolocations of subscribers. Accordingly, the subscriber selection module 314 may select a set of subscribers that are within a predetermined geofenced zone of the campaign stop to receive information regarding the mobile promotion campaign.

In other embodiments, the subscriber selection module 314 may further use a machine-learning algorithm to refine a set of subscribers that are within a predetermined geofenced zone of the campaign stop for candidate subscribers to receive information regarding a mobile promotion campaign. The machine-learning algorithm may be used to compare the customer information of the subscribers in the set of subscribers to one or more campaign parameters of the mobile promotion campaign. For example, a mobile promotion campaign may be configured to target different demographical groups, such as single subscribers, married subscribers, married subscribers with children, etc. The purchase or subscription history of each subscriber may indicate the types of products or service in which the subscriber is likely to have an interest. By using the machine-learning algorithm to compare such data with the promotional product or service details captured in the parameters of a mobile promotion campaign, the subscriber selection module 314 may find a subset of one or more subscribers that best fit the mobile promotion campaign. For example, the one or more subscribers may be determined to be most likely to participate in the mobile promotion campaign, most likely to purchase additional products or services from the merchant because of the promotional product or service offered via the mobile promotion campaign, most likely to provide positive feedback on social media regarding the merchant because of the mobile promotion campaign, and/or so forth. In some instances, the purchase history of a subscriber may contain time-dependent behavior patterns (e.g., daily, monthly, or seasonal patterns) that are analyzed by the machine-learning algorithm to determine whether the subscriber is to be selected for a particular mobile promotion campaign.

Various classification schemes (explicitly and/or implicitly trained) and/or systems (e.g., support vector machines, neural networks, expert systems, Bayesian belief networks, fuzzy logic, data fusion engine, and/or the like) may be implemented as the machine-learning algorithm. A classifier is a function that maps an input attribute vector, x=(x₁, x₂, x₃, x₄, xₙ), to a confidence that the input belongs to a class, that is, f(x)=confidence(class). Such classification may employ a probabilistic and/or statistical-based analysis (e.g., factoring into the analysis utilities and costs) to predict or infer an action that a user desires to be automatically performed. A support vector machine (SVM) is an example of a classifier that may be employed by the dispatch module 414. The SVM operates by finding a hypersurface in the space of possible inputs, which hypersurface attempts to split the triggering criteria from the non-triggering events. Other directed and undirected model classification approaches include, e.g., naïve Bayes, Bayesian networks, decision trees, neural networks, fuzzy logic models, and probabilistic classification models providing different patterns of independence may also be employed.

The route generation module 316 may generate a campaign route for a mobile promotion campaign. In some instances, the route generation module 316 may receive input of waypoints on a digital map that is generated using the LBS map library 136. For example, the waypoints may be the campaign stops for the mobile promotion campaign that are inputted by a user via the campaign module 312. In turn, the route generation module 316 may generate a campaign route for the mobile promotion campaign.

In other instances, the route generation module 316 may generate a campaign route for a mobile promotion campaign by analyzing the historical location information of subscribers. In such instances, the route generation module 316 may use the subscriber selection module 314 to compare the campaign parameters of the mobile promotion campaign to the customer information of a plurality of subscribers to select a set of subscribers as target subscribers for the mobile promotion campaign. In various embodiments, the plurality of subscribers may include subscribers that are currently located in a campaign geographical area that is the target of the mobile promotion campaign. Alternatively, or concurrently, the plurality of subscribers may include subscribers who based on historical location information have previously visited the campaign geographical area within a predetermined time period before the current date and time (e.g., the last 30 days, the last six months, etc.).

Subsequently, the route generation module 316 may use the historical location information of the target subscribers from within the predetermined period of time to determine one or more geographical locations in the campaign geographical area with a concentration of individual target subscribers that exceed a concentration threshold at one or more corresponding times. For example, each of the concentration and the concentration threshold may be measured in a number of subscribers per area (e.g., e.g., a square mile, half a square mile, a quarter of a square mile, etc.). The historical location information of a subscriber may be collected and stored by the route generation module 316 using a client application on a user device of the subscriber after the subscriber has specifically consented to such historical location information collection. For example, the subscriber may consent to such information collection by selecting a checkbox or activating a toggle switch on a user interface presented by the client application. Thus, by using the historical location of the target subscribers, the route generation module 316 may generate a campaign route for the mobile promotion campaign, in which the campaign route places the mobile campaign vehicle at one or more geographical locations at the one or more corresponding times. In some instances, the geographical locations may be pre-selected landmarks or street addresses. In other instances, a geographical location may be a central point of a density analysis (e.g., heat map) sector with a high concentration of individual target subscribers. In the latter instances, the route generation module 316 may translate these central points into nearby street addresses or landmarks for designation into campaign stops.

The flash promotion module 318 may be used to designate locations for the deployment of flash promotion beacons. For example, a user may designate a mobile promotion that is inputted into the campaign module 312 as a flash promotion campaign. Accordingly, the campaign stops that are determined by the route generation module 316 for the mobile promotion campaign may be labeled by the flash promotion module 318 as deployment locations for flash promotion beacons. Accordingly, the flash promotion module 318 may automatically generate a work order for flash promotion beacons to be deployed at the locations. In turn, a work crew of the campaign provider 102 may install the flash promotion beacons at the locations selected by the flash promotion module 318. Further, once the flash promotion campaign is conducted, the flash promotion module 318 may automatically generate a work order for the flash promotion beacons to be removed from the locations.

In some embodiments, the flash promotion module 318 may also receive notifications from mobile applications on mobile devices indicating that corresponding mobile campaign vehicles have detected flash promotion beacons. Following the flash promotion module 318 receiving such a notification, the flash promotion module 318 may forward the notification to the campaign module 312. In turn, the campaign module 312 may determine whether a corresponding mobile campaign vehicle is actively engaged in an on-going mobile promotion campaign. Thus, if the corresponding mobile campaign vehicle is actively engaged, the campaign module 312 may modify one or more parameters of the ongoing mobile promotion campaign to accommodate a flash promotion campaign stop. For example, the campaign module 312 may modify a quantity of products or services offered at the remaining campaign stops of the ongoing mobile promotion campaign. Alternatively, or concurrently, the campaign module 312 may eliminate one or more remaining campaign stops of the ongoing mobile promotion campaign, change the locations of the one or more remaining campaign, shorten the duration of the one or more remaining campaign stops, modify the campaign route of the ongoing mobile promotion campaign, and/or so forth. In at least one instance, the locations of the one or more remaining campaign stops may be changed so that the locations are more than a predetermined distance from the location of the detected flash promotion beacon.

The information distribution module 320 may distribute information regarding mobile promotion campaigns to the client applications of subscribers that are selected by the campaign module 312. In turn, the information may be presented by the client applications to the subscribers. For example, the information may be presented via in-app notifications or messages, pop-up notifications that are displayed on a home screen of a user device, and/or so forth. In various instances, the notification or message may include a web page or in-app page, or a link to such page, that displays a location of a campaign stop for the mobile promotion campaign, as well as information regarding the promotional product or the promotional service offered by the mobile promotion campaign. In some instances, the details may include inventory or quantity information for the promotional product or the promotional service that is updated periodically or in real-time. Other details that may be updated in real-time may include an amount of time that the mobile campaign vehicle has remaining at a mobile campaign stop. In other instances, the details may include content that is dynamically generated by the operator of the mobile application 114 regarding a mobile promotion campaign, such as advertising or promotion messages designed to further engage or motivate eligible subscribers to take advantage of the mobile promotion campaign.

In other embodiments, the information distribution module 320 may include a social media posting function that automatically posts information regarding mobile promotion campaigns to social media sites. In some instances, the information may include inventory or quantity information for the promotional product or the promotional service that is updated periodically or in real-time. In other instances, the information may include content that is dynamically generated by the operator of the mobile application 114 regarding a mobile promotion campaign, such as advertising or promotion messages designed to further engage or motivate eligible subscribers to take advantage of the mobile promotion campaign. In alternative embodiments, the information distribution module 320 may send or post the inventory of a promotional product or quantity information for a promotion service when the inventory of the promotional product or available quantity of the promotional service falls below a corresponding inventory threshold or a corresponding quantity threshold.

The scheduler module 322 may use the information on mobile promotion campaigns to start and stop a subscription to a third-party LBS map library. The scheduler module 322 may query the parameters of the mobile promotion campaigns to determine the start and end date and times of the campaigns. Based on this information, the scheduler module 322 may generate a schedule for activating a subscription to the LBS map library 136 for those times when an active mobile promotion campaign is ongoing, as well as to deactivate the subscription to the LBS map library 136 when no active mobile promotion campaign is occurring.

In some instances, the scheduler module 322 may also deactivate LBS functionalities of client applications on the user devices of subscribers that the merchant has deemed ineligible to participate in mobile promotion campaigns. Alternatively, or concurrently, the scheduler module 322 may deactivate the LBS functionalities of client applications on the user devices of subscribers located in geographical regions not targeted by any ongoing mobile promotion campaign. For example, the scheduler module 322 may query the parameters of the mobile promotion campaigns to determine geographical regions with ongoing campaigns and the geographical locations of user devices with the client applications installed. By comparing such location information, the scheduler module 322 may deactivate the LBS functionalities of client applications that are currently not located in the geographical regions with ongoing campaigns.

### Example Processes

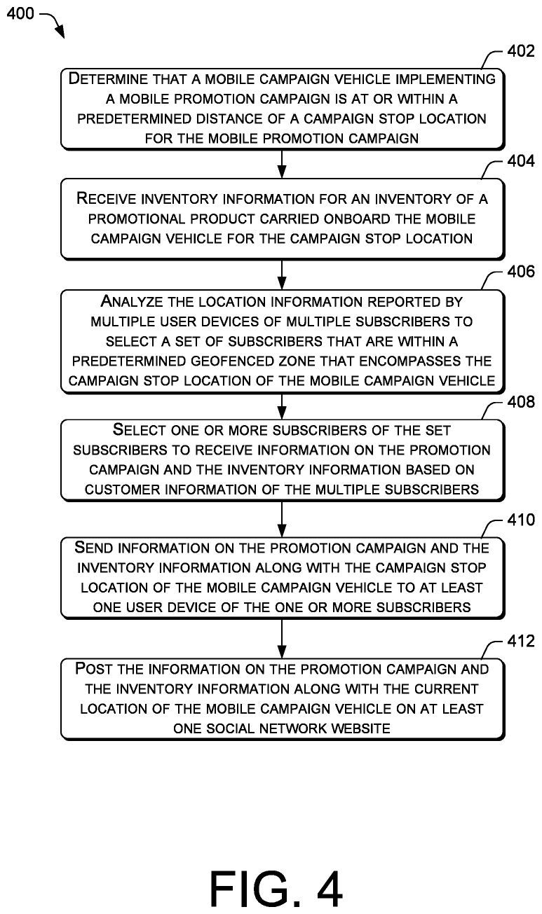

FIGS. 4-9 present illustrative processes 400-900 for a merchant to conduct mobile promotion campaigns to promote the promotional products or services provided by the merchant. Each of the processes 400-900 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, code segments, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 400-900 are described with reference to the architecture 100 of FIG. 1.

FIG. 4 is a flow diagram of an example process 400 for providing information on a promotion campaign that promotes a promotional product along with a campaign stop location of a mobile campaign vehicle to user devices of subscribers. At block 402, the campaign engine 104 may determine that a mobile campaign vehicle implementing a mobile promotion campaign is at or within a predetermined distance of a campaign stop location for the mobile promotion campaign. The campaign engine 104 may make this determination based on information reported by a mobile application on a mobile device as carried onboard the mobile campaign vehicle.

At block 404, the campaign engine 104 may receive inventory information for an inventory of a promotional product carried on the mobile campaign vehicle for the campaign stop location. The inventory information may be reported by the mobile application on the mobile device. At block 406, the campaign engine 104 may analyze the location information reported by multiple user devices of subscribers to select a set of subscribers that are within a predetermined geofenced zone that encompasses the campaign stop location of the mobile campaign vehicle.

At block 408, the campaign engine 104 may select one or more subscribers of the set of subscribers to receive information on the mobile promotion campaign and the inventory information based on the customer information of the multiple subscribers. For example, the customer information of a subscriber may include a promotional product purchase history, a promotional service purchase history, a payment history, a credit history, subscriber demographic information, social media activity data, and/or so forth.

At block 410, the campaign engine 104 may send the information on the mobile promotion campaign and the inventory information along with the campaign stop location of the mobile campaign to at least one user device of the one or more subscribers. The information on the mobile promotion campaign may include details regarding a campaign stop location of the mobile campaign vehicle, the promotional product that is offered for the mobile promotion campaign, a price or a change in the price of the promotional product, the start date and time of the mobile promotion campaign, the end date and time of the mobile promotion campaign, the terms and conditions of the mobile promotion campaign, the amount of time that the mobile campaign vehicle will remain at the campaign stop location, and/or so forth.

However, in alternative embodiments, the campaign engine 104 may forego the operation in block 408 and send the information on the mobile promotion campaign and the inventory information along with the campaign stop location to the multiple user devices of the multiple subscribers. In other alternative embodiments, the campaign engine 104 may be configured to forego the sending of the inventory information to user devices.

At block 412, the campaign engine 104 may post the information on the mobile promotion campaign and the inventory information along with the current location of the mobile campaign vehicle on at least one social networking site. However, in alternative embodiments, the campaign engine 104 may be configured to forego the posting of the inventory information.

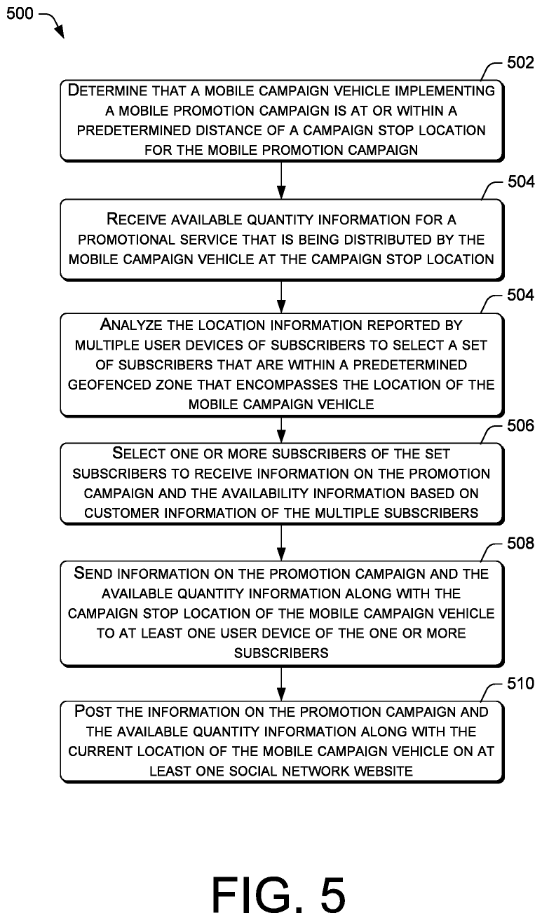

FIG. 5 is a flow diagram of an example process 500 for providing information on a promotion campaign that promotes a promotional service along with a campaign stop location of a mobile campaign vehicle to user devices of subscribers. At block 502, the campaign engine 104 may determine that a mobile campaign vehicle implementing a mobile promotion campaign is at or within a predetermined distance of a campaign stop location for the mobile promotion campaign. The campaign engine 104 may make this determination based on information reported by a mobile application on a mobile device as carried onboard the mobile campaign vehicle.

At block 504, the campaign engine 104 may receive available quantity information for a promotional service that is being distributed by the mobile campaign vehicle at the campaign stop location. The available quantity information may be reported by the mobile application on the mobile device. At block 506, the campaign engine 104 may analyze the location information reported by multiple user devices of subscribers to select a set of subscribers that are within a predetermined geofenced zone that encompasses the campaign stop location of the mobile campaign vehicle.

At block 508, the campaign engine 104 may select one or more subscribers of the set of subscribers to receive information on the mobile promotion campaign and the available quantity information based on the customer information of the multiple subscribers. For example, the customer information of a subscriber may include a promotional product purchase history, a promotional service purchase history, a payment history, a credit history, subscriber demographic information, social media activity data, and/or so forth. At block 510, the campaign engine 104 may send the information on the mobile promotion campaign and the available quantity information along with the campaign stop location of the mobile campaign to at least one user device of the one or more subscribers. The information on the mobile promotion campaign may include details regarding a campaign stop location of the mobile campaign vehicle, the promotional service that is offered for the mobile promotion campaign, a price or a change in price of the promotional service, the start date and time of the mobile promotion campaign, the end date and time of the mobile promotion campaign, the terms and conditions of the mobile promotion campaign, the amount of time that the mobile campaign vehicle will remain at the campaign stop location, and/or so forth.

However, in alternative embodiments, the campaign engine 104 may forego the operation in block 508 and send the information on the mobile promotion campaign and the available quantity information along with the campaign stop location to the multiple user devices of the multiple subscribers. In other alternative embodiments, the campaign engine 104 may be configured to forego the sending of the available quantity information to user devices.

At block 512, the campaign engine 104 may post the information on the mobile promotion campaign and the available quantity information along with the current location of the mobile campaign vehicle on at least one social networking site. However, in alternative embodiments, the campaign engine 104 may be configured to forego the posting of the available quantity information.

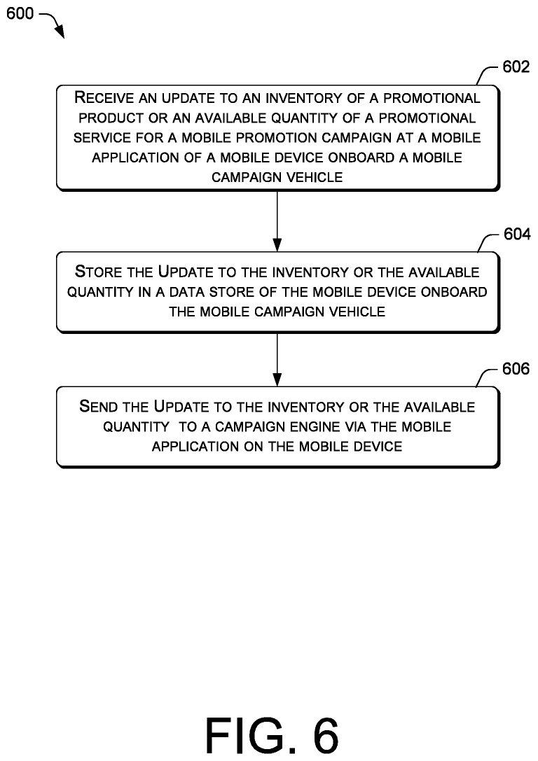

FIG. 6 is a flow diagram of an example process 600 for sending real-time updated inventory information of a promotional product to a campaign engine. At block 602, a mobile application of a mobile device onboard a mobile campaign vehicle may receive an update to an inventory of a promotional product or an available quantity of a promotional service for a mobile promotion campaign. For example, the mobile application 114 of the mobile device 116 onboard the mobile campaign vehicle 110 may receive the update. In some instances, the inventory or available quantity may be updated based on manually inputted or scanned information. In other instances, the inventory or available quantity may be automatically updated by a POS function of the mobile application. The update may be received by the mobile application as the mobile promotion campaign is conducted at one or more campaign stop locations via the mobile campaign vehicle.

At block 604, the mobile application may store the update to the inventory or the available quantity in a data store of the mobile device onboard the mobile campaign vehicle. The update to the inventory may increase or decrease the units of the promotional product available for distribution. Likewise, the update to the available quantity may increase or decrease the units of the promotional service available for distribution.

At block 608, the mobile application may send the update to the inventory or the available quantity to the campaign engine 104. In turn, the campaign engine 104 may distribute the update to the inventory or the available quantity to the client applications of subscribers that are targeted by the mobile promotion campaign. In some instances, the campaign engine 104 may also post the update to one or more social network sites.

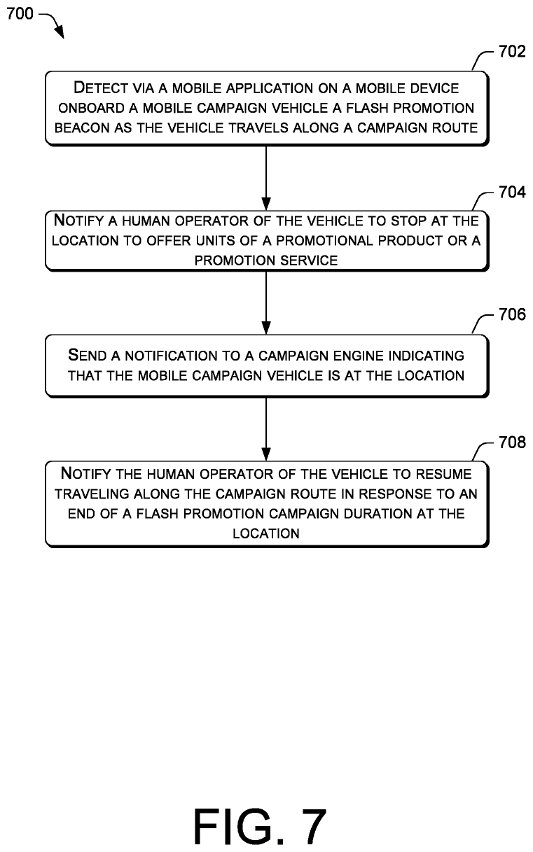

FIG. 7 is a flow diagram of an example process 700 for conducting a flash promotion campaign using a mobile campaign vehicle based on a proximity of the vehicle to a short-range communication beacon. At block 702, a mobile application on a mobile device onboard a mobile campaign vehicle may detect a flash promotion beacon as the vehicle travels along a campaign route. For example, the flash promotion beacon may be a short-range communication device, such as a Bluetooth IoT transceiver. The flash promotion beacon may be placed at a location as a part of a flash promotion campaign.

At block 704, the mobile application may notify a human operator of the vehicle to stop at the location to offer units of a promotional product or a promotional service for the flash promotion campaign. In various embodiments, the mobile application may perform a notification via a pop-up message or alert that is displayed on a screen of the mobile device. In some instances, the pop-up message may be accompanied by an audio alert that is presented via a speaker of the mobile device.

At block 706, the mobile application may send a notification to the campaign engine 104 indicating that the mobile campaign vehicle is at the location. In turn, the campaign engine 104 may select one or more subscribers that are within a geofenced zone that encompasses the location to receive information regarding on the flash promotion campaign, including details on the promotional product or the promotion service. The information may be accompanied by corresponding inventory information for the promotional product or corresponding available quantity for the promotional service. The campaign engine 104 may also post such information to one or more social media sites.

At block 708, the mobile application may notify the human operator of the vehicle to resume traveling along the campaign route in response to an end of a flash campaign duration at the location. In this way, the mobile campaign vehicle may repeat the flash promotion campaign at various locations.

In alternative embodiments, the flash promotion campaign may involve the mobile campaign vehicle dropping off a predetermined quantity of a promotional product at a brick-and-mortar storefront that is proximate to the flash promotion beacon. The brick-and-mortar storefront may be a store that is operated by the merchant or by a third-party merchant that is affiliated with the merchant. In such embodiments, the mobile application may direct the human operator to drop off the units of the promotional product according to one or more campaign parameters provided by the campaign engine 104. Following the drop off, the human operator may use the mobile application to notify the campaign engine 104 that the drop off is complete. In turn, the campaign engine 104 may select one or more subscribers that are within a geofenced zone that encompasses the location to receive information regarding on the flash promotion campaign, including details on the promotional product. The campaign engine 104 may also post such information to one or more social media sites.

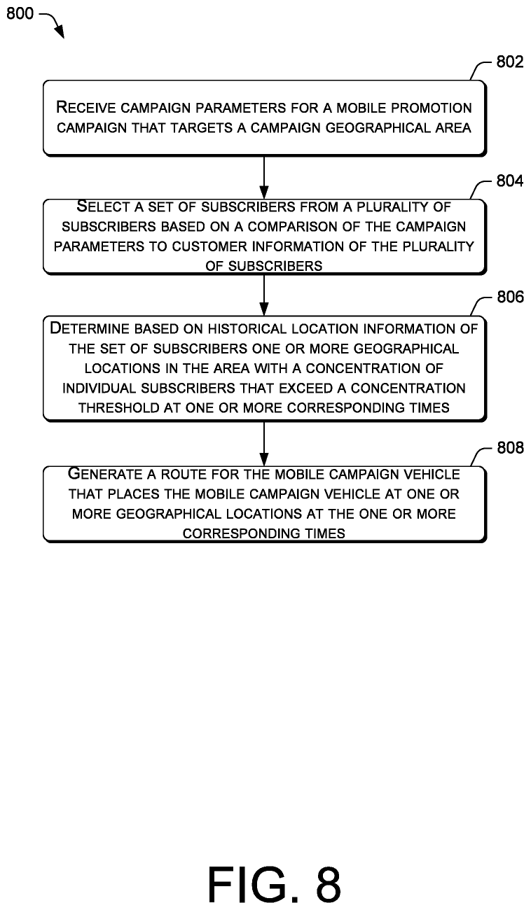

FIG. 8 is a flow diagram of an example process 800 for generating a route for a mobile campaign vehicle based on the customer information and the historical location information of a set of subscribers. At block 802, the campaign engine 104 may receive campaign parameters for a mobile promotion campaign that targets a campaign geographical area. In various embodiments, the parameters may include a description of the promotional product or service that is offered for the mobile promotion campaign, the start date and time of the mobile promotion campaign, the end date and time of the mobile promotion campaign, the details, terms, and conditions of the mobile promotion campaign, the geographical region targeted by the mobile promotion campaign, the quantity of products or services available for the mobile promotion campaign, the campaign route of a mobile campaign vehicle implementing the mobile promotion campaign, campaign stop criteria and campaign geographical area for the mobile promotion campaign, and/or so forth.

At block 804, the campaign engine 104 may select a set of subscribers from a plurality of subscribers based on a comparison of the campaign parameters to the customer information of the plurality of subscribers. In various embodiments, the plurality of subscribers may include subscribers that are currently located within the campaign geographical area. Alternatively, or concurrently, the plurality of subscribers may include subscribers who have previously visited the campaign geographical area within a predetermined time period before the current date and time.

At block 806, the campaign engine 104 may determine based on the historical location information of the set of subscribers one or more geographical locations within the campaign geographical area with a concentration of individual subscribers that exceed a concentration threshold at one or more corresponding times. The historical location information of the set of subscribers may be from the predetermined time period before the current date and time. At block 808, the campaign engine 104 may generate a route that places the mobile campaign vehicle at one or more geographical locations at the one or more corresponding times.

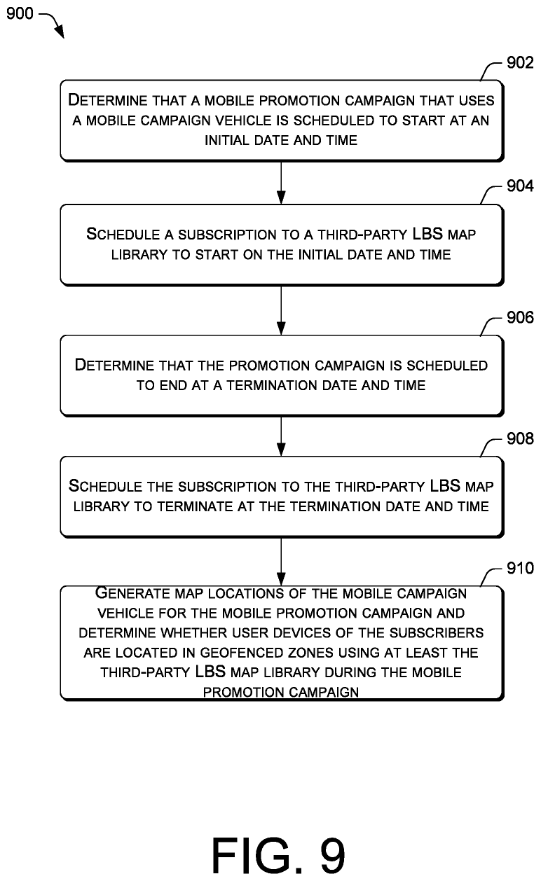

FIG. 9 is a flow diagram of an example process 900 for scheduling a subscription to an LBS map library based on the start and the end of a mobile promotion campaign. At block 902, the campaign engine 104 may determine that a mobile promotion campaign that uses a mobile campaign vehicle is scheduled to start at an initial date and time. At block 904, the campaign engine 104 may schedule a subscription to a third-party LBS map library to start on the initial date and time. At block 906, the campaign engine 104 may determine that the mobile promotion campaign is scheduled at a termination date and time. At block 908, the campaign engine 104 may schedule the subscription to the third-party LBS map library to terminate at the termination date and time. Such selective subscription to the third-party LBS map library may reduce the amount of subscription fees paid to the third-party provider of the LBS map library.

At block 910, the campaign engine 104 may generate map locations of the mobile campaign vehicle for the mobile promotion campaign and determine whether user devices of the subscribers are located in geofenced zones using at least the third-party LB S map library during the mobile promotion campaign. In other embodiments, the campaign engine 104 may also reduce the subscription fees paid by deactivating LBS functionalities of client applications on the user devices of subscribers that are ineligible to participate in mobile promotion campaigns. Alternatively, or concurrently, the campaign engine 104 may deactivate the LBS functionalities of client applications on the user devices of subscribers located in geographical regions not targeted by any ongoing mobile promotion campaign to reduce subscription fees paid to the third-party service provider of the LBS map library.

The use of location-based mobile promotion campaigns may enable a merchant to target the campaigns to customers who are located within specific geographical regions. Further, the use of location-based mobile promotion campaigns may make it more convenient for certain customers to take advantage of the campaigns due to the mobility and the proximity of the campaigns relative to the customers.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable instructions that upon execution cause one or more processors to perform acts comprising:
determining that a mobile campaign vehicle implementing a mobile promotion campaign is at or within a predetermined distance of a campaign stop location for the mobile promotion campaign, the mobile promotion campaign for providing a promotional product or a promotional service;
analyzing location information reported by multiple user devices of subscribers to select a set of subscribers that are within a predetermined geofenced zone that encompasses the campaign stop location of the mobile campaign vehicle; and
sending information on the mobile promotion campaign along with the campaign stop location of the mobile campaign vehicle to at least one user device of one or more subscribers of the set of subscribers that are within the predetermined geofenced zone.

2. The one or more non-transitory computer-readable media of claim 1, wherein the acts further comprise selecting the one or more subscribers of the set of subscribers to receive information on the mobile promotion campaign based on a comparison of campaign parameters of the mobile promotion campaign and customer information of the set of subscribers.

3. The one or more non-transitory computer-readable media of claim 2, wherein the customer information of a subscriber includes one or more of a promotional product purchase history, a promotional service purchase history, a payment history, a credit history, subscriber demographic information, or social media activity data.

4. The one or more non-transitory computer-readable media of claim 2, wherein the campaign parameters of the mobile promotion campaign includes one or more of a description of the promotional product or the promotional service that is offered, a start date and time of the mobile promotion campaign, an end date and time of the mobile promotion campaign, details, terms, and conditions of the mobile promotion campaign, a geographical region targeted by the mobile promotion campaign, a quantity of products or services available for the mobile promotion campaign, a campaign route of a mobile campaign vehicle implementing the mobile promotion campaign, campaign stop criteria, or a campaign geographical area for the mobile promotion campaign.

5. The one or more non-transitory computer-readable media of claim 2, wherein the comparison of the campaign parameters of the mobile promotion campaign and the customer information of the set of subscribers to select one or more subscribers is performed via a machine-learning algorithm.

6. The one or more non-transitory computer-readable media of claim 1, wherein the acts further comprise:
receiving updated inventory information for the promotional product carried onboard the mobile campaign vehicle or updated available quantity information for the promotional service distributed via the mobile campaign vehicle; and
sending the updated inventory information or the updated available quantity information along with the information on the mobile promotion campaign to the at least one user device of the one or more subscribers.

7. The one or more non-transitory computer-readable media of claim 1, wherein the sending the information includes sending an amount of time that the mobile campaign vehicle has remaining at the campaign stop location.

8. The one or more non-transitory computer-readable media of claim 1, wherein the acts further comprise posting the information on the mobile promotion campaign on one more social media sites.

9. The one or more non-transitory computer-readable media of claim 1, wherein the information on the mobile promotion campaign and the campaign stop location of the mobile campaign vehicle are presented to a corresponding subscriber by a client application on the user device.

10. The one or more non-transitory computer-readable media of claim 1, wherein the mobile promotion campaign offers the promotional product or the promotional service for sale, offers an incentive for a purchase of the promotional product or the promotional service, or gives away the promotional product or promotional service.

11. The one or more non-transitory computer-readable media of claim 1, wherein the acts further comprise:
receiving campaign parameters for the mobile promotion campaign that targets a campaign geographical area;
selecting a group of subscribers from a plurality of subscribers based on a comparison of the campaign parameters to subscriber information of multiple subscribers;
determining, based on historical location information of the group of subscribers, one or more geographical locations in the campaign geographical area with a corresponding concentration of individual subscribers at one or more corresponding times that exceeds a corresponding concentration threshold; and
generating a campaign route for the mobile campaign vehicle that places the mobile campaign vehicle at the one or more geographical locations by the one or more corresponding times.

12. The one or more non-transitory computer-readable media of claim 1, wherein the acts further comprise:
determining that the mobile promotion campaign is scheduled to start at an initial date and time and end at a termination date and time; and
scheduling a subscription to a third-party location-based service (LBS) map library to active between the initial date and time and the termination date and time,
wherein the third-party LBS map library is used to determine whether the multiple user devices are within the predetermined geofenced zone and display a current location of mobile campaign vehicle on one or more client applications installed on the at least one user device while the subscription to the third-party LBS map library is active.

13. The one or more non-transitory computer-readable media of claim 10, wherein the acts further comprise at least one of deactivating LBS functionalities of first client applications on first user devices of first subscribers that are ineligible to participate in mobile promotion campaigns, or deactivating the LBS functionalities of second client applications on second user devices of second subscribers located within geographical regions not targeted by any ongoing mobile promotion campaigns wherein the LBS functionalities are configured to use the third-party LBS map library.

14. A computer-implemented method, comprising:
determining via a mobile device onboard a mobile campaign vehicle that the mobile campaign vehicle is proximate to a location marked with a flash promotion beacon of a flash promotion campaign as the mobile campaign vehicle travels along a predetermined route;
presenting, via a mobile application the mobile device, a notification to an operator of the mobile campaign vehicle via the mobile device to direct the operator to stop at the location to provide a promotional product or a promotional service at the location;
sending, via the mobile application the mobile device, an additional notification to a campaign engine on a remote computing device indicating that the mobile campaign vehicle is at the location; and
presenting, via the mobile application the mobile device, a command to the operator of the mobile campaign vehicle via the mobile device to direct the operator to resume traveling along the predetermined route in response to an end of a campaign duration at the location.

15. The computer-implemented method of claim 14, wherein the flash promotion beacon is a Bluetooth device that is used to mark a location for a flash promotion campaign.

16. The computer-implemented method of claim 14, wherein the presenting includes presenting the notification to prompt the operator to drop off one or more units of the promotional product at a storefront that is situated at the location.

17. The computer-implemented method of claim 14, wherein the presenting includes presenting the notification to prompt the operator to at least one of distribute recruitment information or to collect job application material from one or more job applicants at the location as the promotional service.

18. The computer-implemented method of claim 14, where the additional notification causes the campaign engine to analyze location information reported by multiple user devices of subscribers to select a set of subscribers that are within a predetermined geofenced zone that encompasses the location of the mobile campaign vehicle, and send information on the flash promotion campaign along with the location of the mobile campaign vehicle to at least one user device of one or more subscribers of the set of subscribers that are within the predetermined geofenced zone.

19. A system, comprising:
one or more processors; and
memory including a plurality of computer-executable components that are executable by the one or more processors to perform a plurality of actions, the plurality of actions comprising:
determining that a mobile promotion campaign is scheduled to start at an initial date and time and end at a termination date and time, the mobile promotion campaign being conducted via a mobile campaign vehicle that travels along a route within a geographical area to provide a promotional product or a promotional service at one or more campaign stop locations; and
scheduling a subscription to a third-party location-based service (LBS) map library to be active between the initial date and time and the termination date and time; and
while the subscription to the third-party LBS map library is active, determining whether multiple user devices of subscribers are within a predetermined geofenced zone and displaying a current location of mobile campaign vehicle on one or more client applications installed on at least one user device that is located within the predetermined geofenced zone using the third-party LBS map library.

20. The system of claim 19, wherein the plurality of actions further comprise at least one of deactivating LBS functionalities of first client applications on first user devices of first subscribers that are ineligible to participate in mobile promotion campaigns, or deactivating the LBS functionalities of second client applications on second user devices of second subscribers located within geographical regions not targeted by any ongoing mobile promotion campaigns, wherein the LBS functionalities are configured to use the third-party LBS map library.
